(19) United States
(12) Patent Application Publication
(10) Pub. No.: US 2020/0170203 A1
(43) Pub. Date: Jun. 4, 2020

(54) STUMP CUTTER WHEEL AND TOOTH MOUNT SYSTEM

(71) Applicant: Vermeer Manufacturing Company, Pella, IA (US)

(72) Inventor: Matthew Ryan Disselkoen, Pella, IA (US)

(21) Appl. No.: 16/654,388

(22) Filed: Oct. 16, 2019

Related U.S. Application Data
(60) Provisional application No. 62/773,042, filed on Nov. 29, 2018.

(51) Int. Cl. A01G 23/06; B02C 18/06; B02C 13/06; B02C 13/28; B02C 13/30

(52) U.S. Cl. CPC A01G 23/067; B02C 18/06; B02C 2013/2808; B02C 13/2804; B02C 13/30; B02C 13/06

(57) ABSTRACT

A cutter wheel for use with a stump cutter having a drive assembly includes a drive plate having first and second sides and a perimeter. A cutter is attached to one of the sides, the cutter having a contact surface configured to engage the side. The cutter has a leading surface and a trailing surface, and a leading mounting hole defining a leading axis and a trailing mounting hole defining a trailing axis. A reference line passes through the leading axis and the trailing axis. A portion of the perimeter of the drive plate is in a zone defined by: a pair of radial lines extending from the leading axis at angles of 20 degrees and 40 degrees radially outward from the reference line, and a pair of arcs 0.25 in. radially outward and inward, respectively, from the leading surface.

### CROSS-REFERENCE TO RELATED APPLICATIONS

This application claims priority to U.S. Provisional Patent Application No. 62/773,042, filed on Nov. 29, 2018, the entire contents of which are incorporated by reference herein.

### BACKGROUND

The present disclosure relates generally to material reduction machines and processing tools (e.g., cutters) that are adapted to remove items such as tree stumps. Various methods and machines for removing or reducing the size of stumps are known. Examples of stump reduction machines are disclosed in U.S. Pat. No. 6,014,996 titled “Control System for Stump Cutters” issued to Vermeer; U.S. Pat. No. 7,011,124 titled “Stump Grinder Having Automatic Reversing Feed Assembly” issued to Tramor; U.S. Pat. No. 6,026,871 titled “Stump Cutter Safety System” issued to Rayco; and U.S. Pat. No. 6,230,770 titled “Stump Chipper and Method for the Operation Thereof” issued to Vermeer-Holland. Aspects discussed herein also apply to material reduction machines that use a drum, such as horizontal grinders, tub grinders, or mulchers like those discussed in U.S. Pat. Nos. 6,843,435 and 5,950,942.

Many material reduction machines use cutters (with separate ‘teeth’) as processing tools for material reduction. More specifically, the cutters may be separate entities removably coupled to a common drive plate. During operation, the rotation of the drive plate about an axis of rotation causes the teeth to engage the material to be reduced and remove portions that form chips. In existing systems, the layout and positioning of the teeth can inhibit the ejection of material, which adversely impacts the efficiency of the cutter.

### SUMMARY

In one aspect, the invention provides a cutter wheel for use with a stump cutter having a drive assembly. The cutter wheel includes a drive plate having a first side, a second side opposite the first side, and a perimeter. A cutter is attached to one of the first side and the second side of the drive plate, the cutter having a contact surface configured to engage one of the first side and the second side of the drive plate, the cutter further having a leading surface and a trailing surface, and a leading mounting hole defining a leading axis and a trailing mounting hole defining a trailing axis. A reference line passes through the leading axis and the trailing axis. A zone is defined by: a first radial line extending radially outward from the leading axis at an angle of 20 degrees radially outward from the reference line, a second radial line extending radially outward from the leading axis and spaced 40 degrees from the reference line, a first arc located 0.25 in. radially outward from the leading surface, and a second arc positioned 0.25 in. radially inward from the leading surface. A portion of the perimeter of the drive plate is in the zone.

In one aspect, the invention provides a cutter wheel for use with a stump cutter having a drive assembly. The cutter wheel includes a drive plate having a first side, a second side opposite the first side, a plate axis, and a perimeter. A cutter is attached to one of the first side and the second side of the drive plate, the cutter having a contact surface configured to engage one of the first side and the second side of the drive plate, the cutter further having a leading surface and a trailing surface, and a leading mounting hole defining a leading axis and a trailing mounting hole defining a trailing axis. A leading radial axis extends between the plate axis and the leading axis. A leading reference axis passes through the leading axis and oriented at an angle of 90 degrees relative to the leading radial axis. A zone is defined by: a first radial line extending radially outward from the leading axis at an angle of 20 degrees radially outward from the leading reference axis, a second radial line extending radially outward from the leading axis and spaced 40 degrees from the leading reference axis, a first arc located 0.25 in. radially outward from the leading surface, and a second arc located 0.25 in. radially inward from the leading surface. A portion of the perimeter of the drive plate is in the zone.

In yet another aspect, the invention provides a cutter wheel for use with a stump cutter having a drive assembly configured to rotate the cutter wheel in a direction of rotation. A drive plate has a first side, a second side opposite the first side, and a perimeter. A trailing cutter is attached to one of the first side and the second side of the drive plate, the trailing cutter having: a first contact surface configured to engage one of the first side and the second side of the drive plate, a first leading surface, a first trailing surface, a first leading mounting hole defining a first leading axis, a first trailing mounting hole defining a first trailing axis, a first reference line passing through the first leading axis and the first trailing axis, and a first zone defined by: a first radial line extending radially outward from the first leading axis at an angle of 20 degrees radially outward from the first reference line, a second radial line extending radially outward from the first leading axis and spaced 40 degrees from the first reference line, a first arc located 0.25 in. radially outward from the first leading surface, and a second arc located 0.25 in. radially inward from the first leading surface. A leading cutter is attached to one of the first side and the second side of the drive plate and positioned ahead of the trailing cutter relative to the direction of rotation, the leading cutter having: a second contact surface configured to engage one of the first side and the second side of the drive plate, a second leading surface, a second trailing surface, a second leading mounting hole defining a second leading axis, a second trailing mounting hole defining a second trailing axis, a second reference line passing through the second leading axis and the second trailing axis, and a second zone defined by a third radial line extending radially outward from the second trailing axis at an angle of 20 degrees radially outward from the second reference line, a fourth radial line extending radially outward from the second trailing axis and spaced 40 degrees from the second reference line, a third arc located 0.25 in. radially outward from the second trailing surface, and a fourth arc located 0.25 in. radially inward from the second trailing surface. A portion of the perimeter of the drive plate is in the first zone and the second zone.

In yet another aspect, the invention provides a cutter wheel for use with a stump cutter having a drive assembly configured to rotate the cutter wheel in a direction of rotation. A drive plate has a first side, a second side opposite the first side, an axis of rotation, and a perimeter. A trailing cutter is attached to one of the first side and the second side of the drive plate, the trailing cutter having: a first leading surface, a first trailing surface, and a first zone in which the leading surface is substantially aligned with the perimeter of the drive plate. A leading cutter is attached to one of the first side and the second side of the drive plate and positioned ahead of the trailing cutter relative to the direction of rotation, the leading cutter having: a second leading surface, a second trailing surface, and a second zone in which the trailing surface is substantially aligned with the perimeter of the drive plate; and a reference arc centered on the axis of rotation, the reference arc having a first end in the first zone and a second end in the second zone. The perimeter of the drive plate includes a transition portion extending between the leading and trailing cutters, radially below the reference arc, wherein the transition portion extends into both the first zone and the second zone.

### BRIEF DESCRIPTION OF THE DRAWINGS

The foregoing and other features and advantages of the disclosure will be apparent from the more particular description of the embodiments, as illustrated in the accompanying drawings, in which like reference characters refer to the same parts throughout the different figures. The drawings are not necessarily to scale, emphasis instead being placed upon illustrating the principles of the disclosure.

FIG. 1 illustrates a material reduction machine including an exemplary cutter wheel with cutters.

FIG. 2 is a side view of the cutter wheel of FIG. 1 including the cutters.

FIG. 3 is a front view of the cutter wheel of FIG. 2 including the cutters.

FIG. 4 is a section view of the cutter wheel taken along line 4-4 of FIG. 3.

FIG. 5 is an enlarged view of a portion of the cutter wheel including cutters.

FIG. 5A is an enlarged view of a cutter attached to the cutter wheel.

FIG. 6 is an enlarged view of one cutter on the cutter wheel.

FIG. 7 is a perspective view of an exemplary cutter.

FIG. 8 is a side view of the cutter of FIG. 7.

FIG. 9 is a front view of the cutter of FIG. 7.

FIG. 10 is a section view taken along line 10-10 of FIG. 2.

FIG. 11 is a section view taken along line 11-11 of FIG. 2.

### DETAILED DESCRIPTION

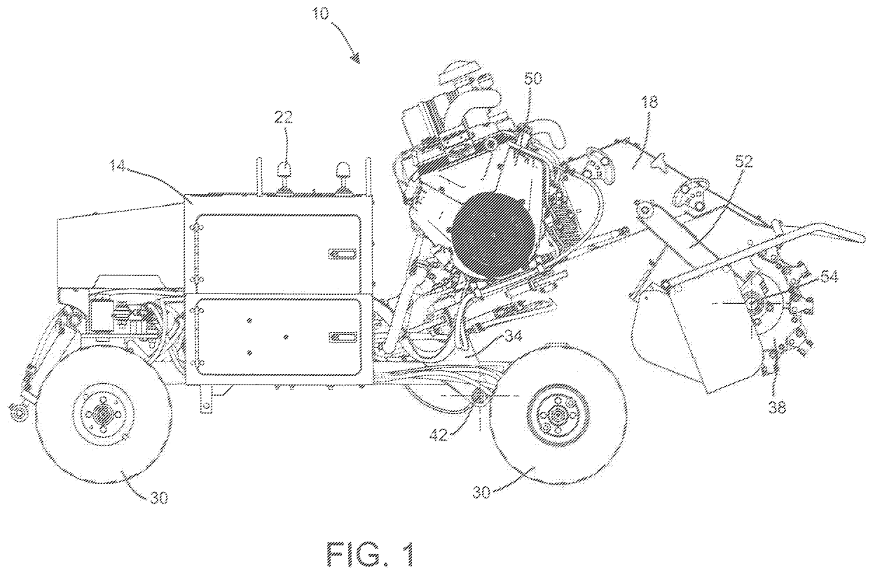

FIG. 1 depicts an exemplary material reduction machine 10 that includes a mainframe 14 and a cutter system 18 attached to the mainframe 14. The illustrated machine 10 is represented as a vehicle with an exterior control panel 22, an engine 50, and wheels 30. For this machine 10, an operator stands beside the exterior control panel 22 to control operation of the material reduction machine 10. The engine 50 houses an engine for powering the material reduction machine 10. The wheels 30 maneuver the material reduction machine 10 across a working terrain. It should be appreciated that the machine 10 may take different forms without deviating from the scope of the invention.

The cutter system 18 is coupled to the mainframe 14 via a sub-frame 34. The sub-frame 34 is configured to raise and lower a cutter wheel 38 relative to the mainframe 14 (e.g., along axis 42 in FIG. 1) as well as lateral movement (e.g., pivotal movement in a generally horizontal direction). The sub-frame 34 also supports a cutter wheel drive system 52 that powers and rotates the cutter wheel 38 about an axis of rotation 54. The drive system 52 includes a series of belts (not shown) and other drive system components for rotating the cutter wheel 38. It should be understood that the cutter wheel 38 can be driven by other suitable power transfer means.

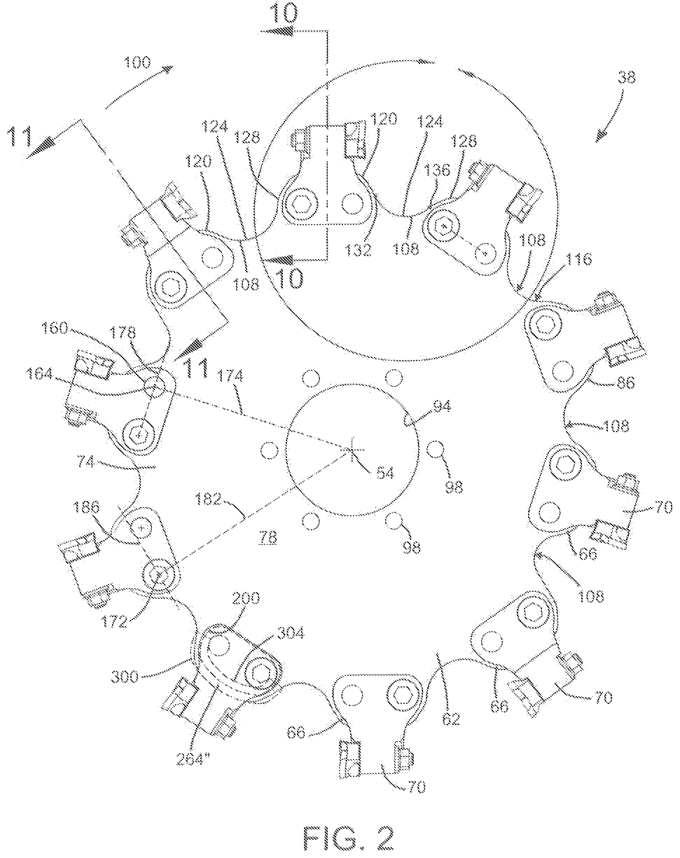

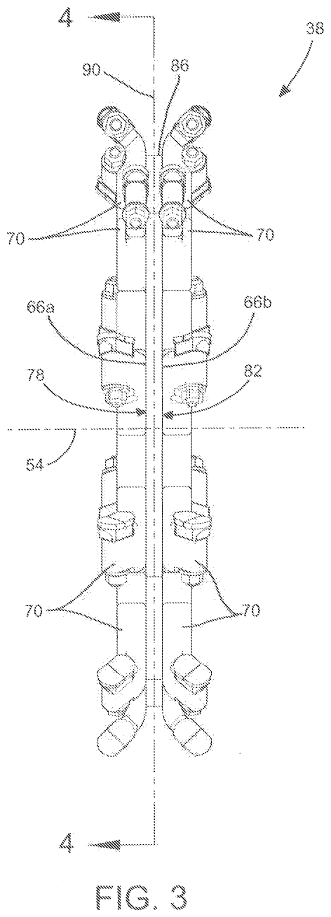

As shown in FIGS. 2-6, the cutter wheel 38 includes a drive plate 62 that has side mounting locations 66 (not all numbered), and cutters 70 (not all numbered). Each cutter is removably attached to the drive plate 62 at a corresponding one of the side-mounting locations 66. As shown, each side mounting location 66 includes two through-holes, although fewer or more through holes can be provided depending on the type of cutter that is mounted to the drive plate 62. The drive plate 62 includes a disk shaped body 74 that has a first side 78, a second side 82 opposite the first side 78, and a perimeter 86. The drive plate 62 defines a mid-plane 90 oriented substantially normal to the axis of rotation 54 and is located midway between the first side 78 and the second side 82.

The drive plate 62 further defines a driveshaft aperture 94 and a plurality of driveshaft mounting holes 98 (not all numbered). The driveshaft aperture 94 and the driveshaft mounting holes 98 cooperatively provide an interface for mounting the drive plate 62 to the drive system 52 and transmitting torque therebetween. More specifically, the driveshaft aperture 94 and driveshaft mounting holes 98 are configured to permit the drive system 52 to rotate the drive plate 62 about the axis of rotation 54 in a direction of rotation 100.

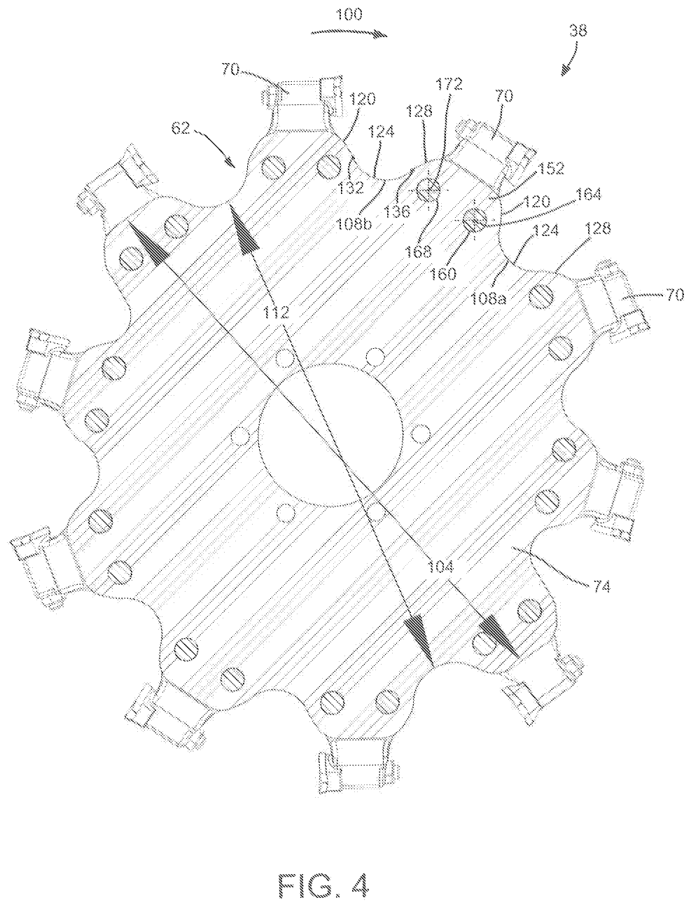

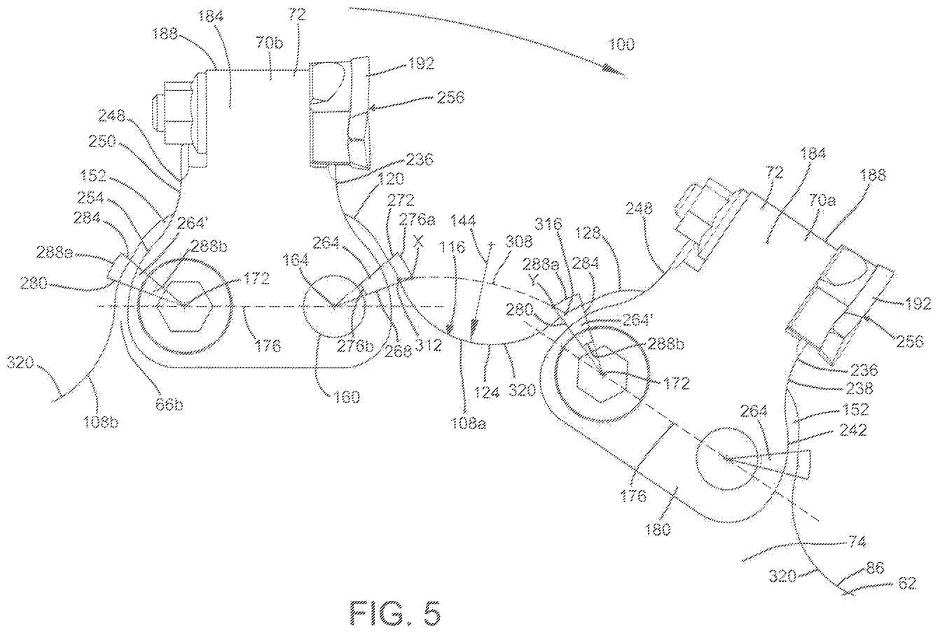

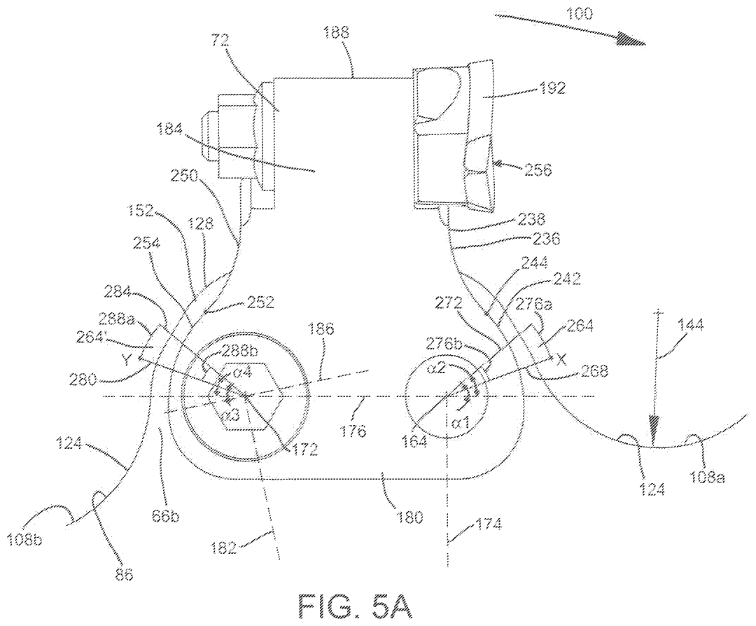

The perimeter 86 extends generally circumferentially about the body 74 to define an outer disk dimension 104 (see FIG. 4), and includes gullets or chip evacuation portions 108. Each chip evacuation portion 108 defines a pocket or recess relative to the outer dimension 104 and is substantially concave in shape with an inner dimension 112 that is smaller than the outer disk dimension 104. More specifically, each chip evacuation portion 108 is defined by an arcuate surface 116 that includes a first convex portion 120, a concave portion 124 (defining the “valley” of the chip evacuation portion 108), and a second convex portion 128. Each illustrated chip evacuation portion 108 also has a first inflection point 132 at the transition between the first convex portion 120 and the concave portion 124, and a second inflection point 136 at the transition between the concave portion 124 and the second convex portion 128. The concave portion 124 can be semi-circular, following a constant radius 144 (see FIG. 5). In other constructions, the concave portion 124 can have other contours (e.g., variable radius). The outer disk dimension 104 and inner dimension 112 can be diameters in the case of a circular disk, or as illustrated, the drive plate 62 can have an elliptical or oval shape with major and minor axes. The drive plate minor axis may be at least 0.85 times the major axis in some constructions such that the drive plate 62 is generally near circular.

As illustrated, each chip evacuation portion 108 is the same size and shape, although the chip evacuation portions 108 may be different from each other in size (e.g., the depth of the chip evacuation portion 108 relative to the outer disk dimension 104) and/or shape (e.g., the contour of curvature(s) defining each chip evacuation portion 108). Also, while the illustrated chip evacuation portions 108 are spaced evenly around the perimeter 86, it should be understood that the chip evacuation portions 108 may be spaced unevenly around the perimeter 86.

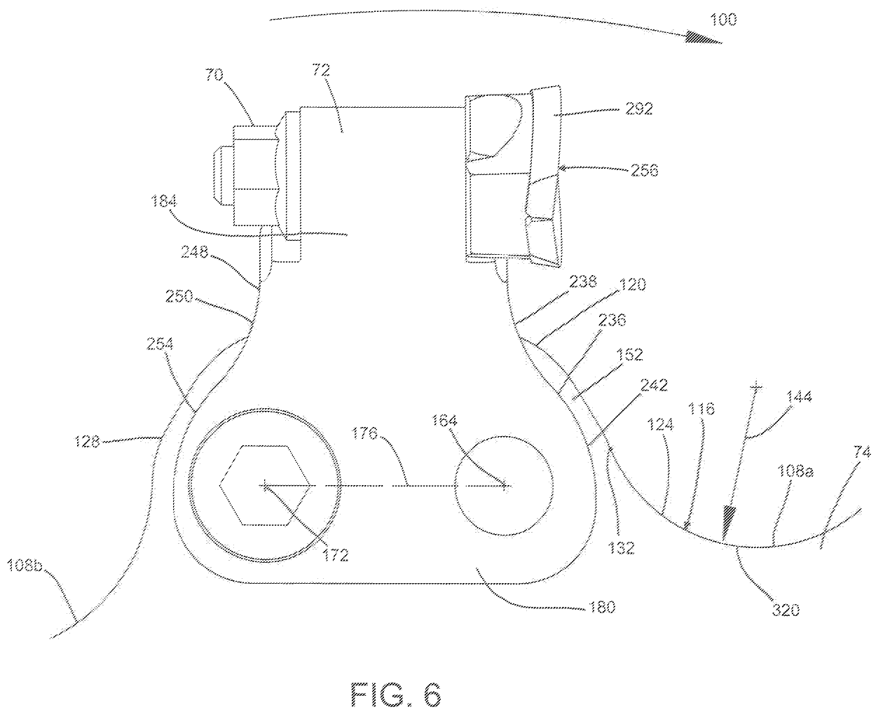

With reference to FIG. 5, the drive plate 62 also includes mounting tabs 152 that are positioned between and partially defined by adjacent chip evacuation portions 108 (i.e. a leading or first chip evacuation portion 108a and a trailing or second chip evacuation portion 108b in the direction of travel). Each mounting tab 152 also includes a first side mounting location 66a on the first side 78 of the plate 62, and a second side mounting location 66b opposite the first side mounting location 66a and on the second side 82 of the plate 62. A first mounting hole 160 is positioned proximate the first convex portion 120 of the leading chip evacuation portion 108a and has a leading axis 164, and a second mounting hole 168 is positioned proximate the second convex portion 128 of the trailing chip evacuation portion 108b and defining a trailing axis 172 (see FIG. 4). Although not shown, additional mounting holes may also be present at each mounting location 66a, 66b to correspond with the hole mounting pattern of a corresponding cutter. As shown in FIGS. 4 and 6, the mounting holes 160, 168 are aligned on a reference axis 176 that extends through the leading axis 164 and the trailing axis 172. In the illustrated embodiment, the leading axis 164 and the trailing axis 172 are parallel to the axis of rotation 54.

With reference to FIG. 5A, a leading radial axis 174 extends between the axis of rotation 54 and the leading axis 164, and a leading reference axis passes through the leading axis 164. The leading reference axis is oriented at an angle of 90 degrees relative to the leading radial axis 174. Thus, the leading reference axis happens to be coincident with the tab reference axis 176 in the illustrated construction, and the leading reference axis is not separately labeled. Similarly, a trailing radial axis 182 extends between the axis of rotation 54 and the trailing axis 172, and a trailing reference axis 186 passes through the trailing axis 172. The trailing reference axis is oriented at an angle of 90 degrees relative to the trailing radial axis 182.

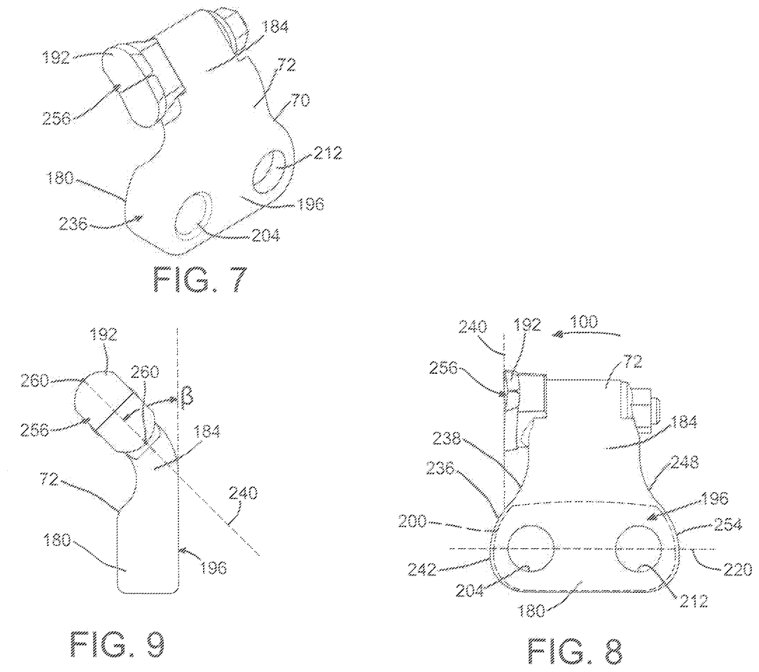

As shown in FIGS. 7-10, each cutter 70 is securely mounted to one of the side mounting locations 66a, 66b for rotation in the direction of rotation 100. Each cutter 70 includes a body 72, a contact surface 196 that directly engages the first side 78 or the second side 82 of the drive plate 62 depending on the mounting location 66a, 66b for the cutter 70, and a cutter tooth 192 that is coupled to the body 72.

The body 72 of the cutter 70 includes a base portion 180 and an arm portion 184 that extends from the base portion 180 to define a distal end 188. As shown in FIGS. 5A, 6 and 8, the arm portion 184 and the base portion 180 cooperatively define a leading surface 236 and a trailing surface 248. The illustrated leading surface 236 has a concave portion 238 extending along the side of the arm portion 184, a convex portion 242 extending from the concave portion 238, and an inflection point 244 between the concave portion 238 and the convex portion 242. The convex portion 242 of the leading surface 236 extends approximately the same length as the first convex portion 120 of the leading chip evacuation portion 108a. It will be appreciated that the leading surface 236 can have a different generally concave profile while remaining within the scope of the present invention. As shown in FIG. 5A, the concave portion 238 is generally positioned behind the leading tooth surface 256 relative to the direction of rotation 100.

The illustrated trailing surface 248 has a profile that mirrors the profile of the leading surface 236 such that the trailing surface 248 has a concave portion 250 extending along the side of the arm portion 184, a convex portion 254 extending from the concave portion 250, and an inflection point 252 between the concave portion 250 and the convex portion 254. The convex portion 254 extends approximately the same length as the second convex portion 128 of the trailing chip evacuation portion 108b. As shown in FIGS. 6 and 8, the base portion 180 and the mounting tab 152 have approximately the same, or the same, width or extent such that the size and shape of the leading and trailing surfaces 236, 248 matches and aligns with the surfaces or profiles of the leading and trailing chip evacuation portions 108a, 108b, respectively, when the cutter 70 is mounted on the drive plate 62.

The body 72 of the cutter 70 includes a first mounting hole 204 positioned proximate the leading surface 236 (e.g., the convex portion 242), and a second mounting hole 212 positioned proximate the trailing surface 248 (e.g., the convex portion 254). When assembled, the first mounting hole 204 and the second mounting hole 212 are configured to substantially align with the first mounting hole 160 and second mounting hole 168 of the mounting tab 152, respectively, so that a fastener can extend through the holes and secure the cutter 70 to the drive plate 62.

Each cutter tooth 192 is coupled to the arm portion 184 adjacent the distal end 188. With respect to FIGS. 7-9, the cutter tooth 192 has a leading tooth surface 256 defined by two cutter portions and is engageable with material to be reduced. The two cutter portions define respective cutting edges or tips 260, and are angled and converge at a juncture that defines a first plane located behind a second plane extending through the outer tips 260 of the two cutter portions. As shown in FIG. 9, the leading tooth surface 256 is generally elliptical in shape (when viewed generally from the leading direction looking at the face of the tooth) and defines an ejection axis 240 that is substantially parallel to the major axis of the elliptical tooth 192. The ejection axis 240 can be oriented at an angle β with respect to the contact surface 196. Each cutter 70 can be configured and used in several different configurations on the drive plate 62. First, the cutter tooth 192 is reversible on the cutter body 72 to change which of the cutting edges or tips 260 is positioned radially outward. Furthermore, each cutter 70 is reversible on the drive plate 62 (i.e., from the first side 78 to the second side 82 and vice versa). When reversed as such, the tooth 192 is repositioned to the other side of the cutter body 72 (i.e. what was the leading side becomes the trailing side and vice versa) via the identical mounting structure for the tooth 192 on the leading and trailing sides of the cutter 70. In some constructions, rather than moving all the cutters 70 from the first side 78 to the second side 82 and vice versa, the cutter teeth 192 are reversed on the respective cutter bodies 72.

The cutter 70 and the chip evacuation portion 108 cooperatively define a chip evacuation feature that facilitates chip flow away from the cutter 70 during use. More specifically, the perimeter 86 of the drive plate 62 and the leading and trailing surfaces 236, 248 of the cutter 70 interact to form the generally concave chip evacuation feature that discharges reduced material away from the cutter wheel 38. As shown in FIGS. 5 and 5A, the cutter wheel 38 has a zone or region 264 that is defined by a portion of the drive plate 62 and a portion of the cutter 70 that facilitates effective and efficient chip evacuation. The zone 264 is bounded by a first radial line 268 extending radially outward (in the direction of rotation 100) from the leading axis 164 (of mounting hole 160) at an angle α1 of 20 degrees relative to the tab reference axis 176, and a second radial line 272 extending radially outward (in the direction of rotation 100) from the leading axis 164 at an angle α2 of 40 degrees relative to the tab reference axis 176. The zone 264 is further bounded on radially outward and inward ends by respective lines 276a, 276b (e.g., arcs centered at the leading axis 164 and extending between the two radial lines 268, 272). The radially outer and inner lines 276a, 276b are located within 0.25 in. of the leading surface 236 of the cutter body 72 in the radial direction relative to the leading axis 164 (i.e., the respective lines 276a, 276b are offset radially outward and inward from the leading surface 236). As illustrated, this zone 264 corresponds to the area that includes the convex portion 242. The intersection of the first radial line 268 with the radially outer zone boundary arc 276a defines a leading point X of the zone 264 (with respect to the direction of rotation 100).

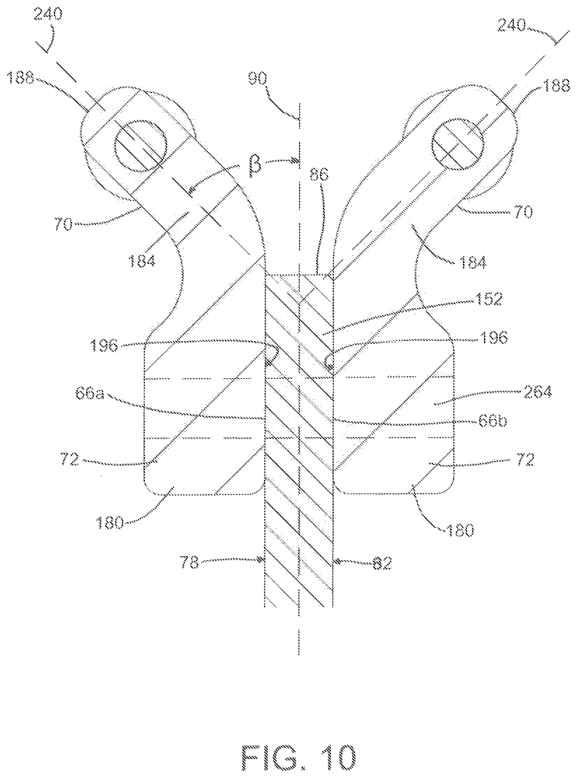

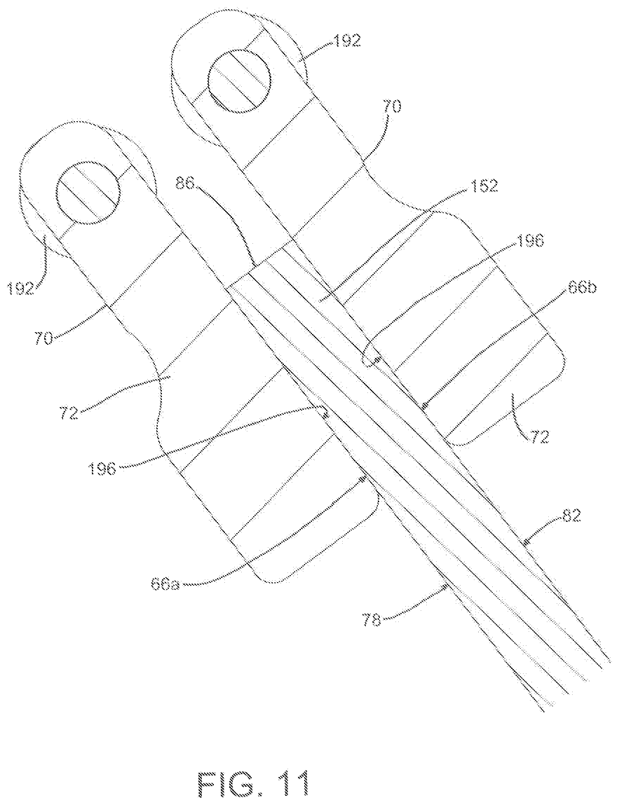

With reference to FIGS. 5A and 10, it will be appreciated that the zone 264 is three-dimensional and projects parallel to the axis of rotation 54 (e.g., normal to the first and second sides 78, 82). In FIG. 10, the zone 264 extends between the two horizontal dashed lines along the base portions 180 of the cutters 70. As such, the cutter wheel 38 has a part of the base portion 180 and a part of the perimeter 86 (i.e., part of the chip evacuation portion 108 between the first and second radial lines 268, 272) that are in the zone 264. Stated another way, the zone 264 encompasses the portions of the respective surfaces of the drive plate 62 and the cutter 70 that are aligned or that have a similar profile shape. In some embodiments, the angle α2 from the tab reference axis 176 to the second radial line 272 may be more than the angle α1 (e.g., 20 degrees) and up to 30 degrees. In other embodiments, the lines 276a, 276b may be within 0.13 in. of the leading surface 236 of the cutter body 72 on either radial side of the leading surface 236. The location of the zone 264 also can be described as being bounded by i) the first radial line 268 extending radially outward (in the direction of rotation 100) from the leading axis 164 at an angle α1 of 20 degrees relative to the leading reference axis (coincident with tab reference axis 176 as shown), and ii) a second radial line 272 extending radially outward (in the direction of rotation 100) from the leading axis 164 at an angle α2 of 40 degrees relative to the leading reference axis.

As illustrated, the wheel 38 includes a zone 264′ on the trailing side of the drive plate 62 and the cutter 70 that has the same delineated area as that described above regarding the zone 264 (i.e., the zone 264′ mirrors the zone 264). In particular, the zone 264′ is bounded by a first radial line 280 extending radially outward (opposite the direction of rotation 100) from the trailing axis 172 (of mounting hole 168) at an angle α3 of 20 degrees relative to the tab reference axis 176, and a second radial line 284 extending radially outward (opposite the direction of rotation 100) from the trailing axis 172 at an angle α4 of 40 degrees relative to the tab reference axis 176. The zone 264′ is further bounded on radially outward and inward ends by respective lines 288a, 288b (e.g., arcs centered at the trailing axis 172 and extending between the two radial lines 280, 284). The radially outer and inner lines 288a, 288b are located within 0.25 in. of the trailing surface 248 of the cutter body 72, which in the illustrated embodiment is convex portion 254 on the trailing side of the cutter body 72 in the radial direction relative to the trailing axis 172 (i.e., the respective lines 288a, 288b are offset radially outward and inward from the trailing surface 248). As illustrated, this zone 264′ corresponds to the area that includes the convex portion 254. The intersection of the first radial line 280 with the radially outward zone boundary arc 288a defines a trailing point Y of the zone 264′ (with respect to the direction of rotation 100).

The zone 264′ is three dimensional and projected parallel to the axis of rotation 54 (e.g., normal to the first and second sides 78, 82). As such, the wheel 38 has a part of the base portion 180 and a part of the perimeter 86 (i.e., part of the chip evacuation portion 108 between the first and second radial lines 280, 284) that are in the zone 264′. Stated another way, the zone 264′ encompasses the portions of the respective surfaces of the drive plate 62 and the cutter 70 that are aligned or that have a similar profile shape. In some embodiments, the angle α4 from the tab reference axis 176 to the second radial line 284 may be more than the angle α3 (e.g., 20 degrees) and up to 30 degrees. In other embodiments, the lines 288a, 288b may be within 0.13 in. of the trailing surface 248 on either radial side of the trailing surface 248. The location of the zone 264′ also can be described as being bounded by i) the first radial line 280 extending radially outward (away the direction of rotation 100) from the trailing axis 172 at an angle of 20 degrees relative to the trailing reference axis 186, and ii) the second radial line 284 extending radially outward (away the direction of rotation 100) from the trailing axis 172 at an angle of 40 degrees relative to the trailing reference axis 186.

With reference to FIG. 2, in some embodiments the wheel 38 may have a zone 264″ that is delineated between i) a first offset curve 300 that is located 0.25 in. beyond the boundary 200 of the contact surface 196 (i.e. where the contact surface 196 no longer contacts the drive plate 62), and ii) a second offset curve 304 that is 0.25 in. inward from the boundary 200. The zone 264″ is three dimensional and projected parallel to the axis of rotation 54 (e.g., normal to the first and second sides 78, 82). In these embodiments, the perimeter 86 of the drive plate 62 is within the zone 264″ for all of the cutters 70 that are mounted to the perimeter 86 of the drive plate 62. In some constructions, the first arc 300 and the second arc 304 may be spaced 0.13 in. from the boundary 200. It will be appreciated that the cutter wheel 38 may have some combination of the zones 264, 264′, 264″.

A cutter pair refers to cutters 70 that are adjacent each other on the perimeter 86, with one cutter 70a defined as the leading cutter in the direction of rotation 100, and the other cutter 70b defined as the trailing cutter (see FIG. 5). With reference to FIG. 5, both cutters 70a, 70b of the cutter pair are mounted to the drive plate 62 such that at least a portion of the arm portion 184 of the cutter 70 extends beyond the perimeter 86 of the drive plate 62. Due to this arrangement, the drive plate 62 does not interfere with material reduction or chip flow from the cutter tooth 192.

Each the zones 264, 264′, 264″ applies to each of the cutters 70a, 70b of each consecutively-mounted cutter pair on the drive plate 62. One chip evacuation portion 108 is disposed between the cutter pair, with the zone 264, 264′, 264″, corresponding to where the profiles of the drive plate 62 and the cutter pair (trailing side of the leading cutter 70a and the leading side of the trailing cutter 70b) align with each other. As shown, the perimeter 86 of the drive plate 62 has the same alignment zones 264, 264′, 264″ for the cutter pair.

With reference to FIG. 5, a reference arc 308 is defined between the consecutive cutters 70a, 70b of the cutter pair. The reference arc 308 is a constant-radius or “semicircular” arc centered on the axis of rotation 54 of the drive plate 62. The reference arc 308 passes into or through the zones 264, 264′ (e.g., through the trailing point Y of the zone 264′ of the leading cutter 70a, and through leading point X of the zone 264 of the trailing cutter 70b). The reference arc 308 (in side view along the axis 54) intersects the drive plate 62 at a first point 312 and at a second point 316. As shown, a portion of the perimeter 86 between the first and second points 312, 316 (i.e. a transition portion 320 of the perimeter 86 extending between the zones 264, 264′) is located below the reference arc 308. Thus, the perimeter 86 between the cutters 70a, 70b is in the zone 264, in the zone 264′, and below the reference arc 308.

The chip evacuation features minimize the potential for failure of the wheel 38 due to jamming caused by chips that may otherwise accumulate during use of the cutter wheel 38. Further, the addition of chip evacuation features reduces the wear on the cutter wheel 38 adjacent each tooth 192. In addition, the positioning of the cutters relative to each other has been found to affect the productivity and other aspects of performance of the cutter wheel 38. There are advantages to positioning the cutters relatively close to one another. For example, and with reference to FIGS. 2 and 5, the close proximity of the leading and trailing cutters 70a, 70b in each cutter pair (e.g., any two consecutive cutters 70 as shown in FIGS. 2 and 5) and the alignment zones 264, 264′, 264″, impact, in a positive way, the chip evacuation characteristics of the wheel 38 and the reliability of the cutter mounting. Configuring the drive plate 62 so that the perimeter 86 aligns with the base portion 180 in the zone 264, 264′, 264″ of the leading cutter 70a and the base portion 180 in the zone 264, 264′, 264″ of the trailing cutter 70b minimizes restriction of the flow of chips being dispelled by the trailing cutter 70b. As shown in FIGS. 5 and 5A, the perimeter 86 of the drive plate 62 has an overall concave profile between cutter pairs 70a, 70b and remains radially inward of the reference arc 308 between the first point 312 and the second point 316. The perimeter 86 of the drive plate 62 between these two points (i.e. between the leading and trailing cutters 70a, 70b) can take many different shapes. The advantage of the drive plate 62 with portions that are in zones 264, 264′, 264″ is that the chips can be more freely discharged away from the wheel 38 along the chip evacuation axis 240. Furthermore, the cutter 70 extends beyond the perimeter 86 of the drive plate 62 such that the drive plate 62 does not block, at least in a significant way, the leading surface 236 of the cutter 70. This facilitates more efficient chip evacuation by limiting or minimizing interference between chip flow and the drive plate 62.

What is claimed is:

1. A cutter wheel for use with a stump cutter having a drive assembly, the cutter wheel comprising:
a drive plate having a first side, a second side opposite the first side, and a perimeter;
a cutter attached to one of the first side and the second side of the drive plate, the cutter having a contact surface configured to engage one of the first side and the second side of the drive plate, the cutter further having a leading surface and a trailing surface, and a leading mounting hole defining a leading axis and a trailing mounting hole defining a trailing axis;
a reference line passing through the leading axis and the trailing axis; and
a zone defined by a first radial line extending radially outward from the leading axis at an angle of 20 degrees radially outward from the reference line, a second radial line extending radially outward from the leading axis and spaced 40 degrees from the reference line, a first arc located 0.25 in. radially outward from the leading surface, and a second arc positioned 0.25 in. radially inward from the leading surface, and wherein a portion of the perimeter of the drive plate is in the zone.

2. The cutter wheel of claim 1, wherein both the leading axis and the trailing axis are normal to at least one of the first side and the second side.

3. The cutter wheel of claim 1, further comprising a second zone within an area defined by a third radial line extending radially outward from the trailing axis at an angle of 20 degrees radially outward from the reference line, a fourth radial line extending radially outward from the trailing axis at an angle of 40 degrees from the reference line, a third arc positioned 0.25 in. radially outward from the trailing surface, and a fourth arc positioned 0.25 in. radially inward from the trailing surface, and wherein the perimeter of the drive plate passes through the second zone.

4. The cutter wheel of claim 3, wherein the fourth radial line is spaced 30 degrees from the third radial line.

5. The cutter wheel of claim 3, wherein the fourth radial line is spaced 20 degrees from the third radial line.

6. The cutter wheel of claim 1, wherein the second radial line is spaced 30 degrees from the first radial line.

7. The cutter wheel of claim 1, wherein the second radial line is spaced 20 degrees from the first radial line.

8. The cutter wheel of claim 1, wherein the cutter includes a cutter tooth mounted thereto, and wherein the cutter tooth may be mounted to the cutter in two or more orientations.

9. The cutter wheel of claim 1, further comprising a second cutter attached to one of the first side and the second side of the drive plate, the second cutter having a second contact surface configured to engage one of the first side and the second side of the drive plate, wherein the second cutter further having a second leading surface and a second trailing surface, and a second leading mounting hole defining a second leading axis and a second trailing mounting hole defining a second trailing axis; and
a second zone defined by a third radial line extending radially outward from the second leading axis at an angle of 20 degrees radially outward from the reference line, a fourth radial line extending radially outward from the second leading axis and spaced 40 degrees from the reference line, a third arc located 0.25 in. radially outward from the second leading surface, and a fourth arc positioned 0.25 in. radially inward from the second leading surface, and
wherein a portion of the perimeter of the drive plate is in the second zone.

10. The cutter wheel of claim 9, further comprising a third zone defined by a fifth radial line extending radially outward from the trailing axis at an angle of 20 degrees radially outward from the reference line, a sixth radial line extending radially outward from the trailing axis and spaced 40 degrees from the reference line, a fifth arc located 0.25 in. radially outward from the trailing surface, and a sixth arc located 0.25 in. radially inward from the trailing surface; and
wherein a portion of the perimeter of the drive plate is in the third zone.

11. The cutter wheel of claim 10, further comprising a fourth zone defined by a seventh radial line extending radially outward from the second trailing axis at an angle of 20 degrees radially outward from the reference line, an eighth radial line extending radially outward from the second trailing axis and spaced 40 degrees from the reference line, a seventh arc located 0.25 in. radially outward from the second trailing surface, and an eighth arc located 0.25 in. radially inward from the second trailing surface; and
wherein a portion of the perimeter of the drive plate is in the fourth zone.

12. A cutter wheel for use with a stump cutter having a drive assembly, the cutter wheel comprising:
a drive plate having a first side, a second side opposite the first side, a plate axis, and a perimeter;
a cutter attached to one of the first side and the second side of the drive plate, the cutter having a contact surface configured to engage one of the first side and the second side of the drive plate, the cutter further having a leading surface and a trailing surface, and a leading mounting hole defining a leading axis and a trailing mounting hole defining a trailing axis;
a leading radial axis extending between the plate axis and the leading axis;
a leading reference axis passing through the leading axis and oriented at an angle of 90 degrees relative to the leading radial axis; and
a zone defined by a first radial line extending radially outward from the leading axis at an angle of 20 degrees radially outward from the leading reference axis, a second radial line extending radially outward from the leading axis and spaced 40 degrees from the leading reference axis, a first arc located 0.25 in. radially outward from the leading surface, and a second arc located 0.25 in. radially inward from the leading surface, and
wherein a portion of the perimeter of the drive plate is in the zone.

13. A cutter wheel for use with a stump cutter having a drive assembly configured to rotate the cutter wheel in a direction of rotation, the cutter wheel comprising:
a drive plate having a first side, a second side opposite the first side, and a perimeter;
a trailing cutter attached to one of the first side and the second side of the drive plate, the trailing cutter having:
a first contact surface configured to engage one of the first side and the second
side of the drive plate,
a first leading surface,
a first trailing surface,
a first leading mounting hole defining a first leading axis,
a first trailing mounting hole defining a first trailing axis,
a first reference line passing through the first leading axis and the first trailing axis, and
a first zone defined by a first radial line extending radially outward from the first leading axis at an angle of 20 degrees radially outward from the first reference line, a second radial line extending radially outward from the first leading axis and spaced 40 degrees from the first reference line, a first arc located 0.25 in. radially outward from the first leading surface, and a second arc located 0.25 in. radially inward from the first leading surface; and
a leading cutter attached to one of the first side and the second side of the drive plate and positioned ahead of the trailing cutter relative to the direction of rotation, the leading cutter having:
a second contact surface configured to engage one of the first side and the
second side of the drive plate,
a second leading surface,
a second trailing surface,
a second leading mounting hole defining a second leading axis, a second trailing mounting hole defining a second trailing axis,
a second reference line passing through the second leading axis and the second trailing axis,
a second zone defined by a third radial line extending radially outward from the second trailing axis at an angle of 20 degrees radially outward from the second reference line, a fourth radial line extending radially outward from the second trailing axis and spaced 40 degrees from the second reference line, a third arc located 0.25 in. radially outward from the second trailing surface, and a fourth arc located 0.25 in. radially inward from the second trailing surface, and
wherein a portion of the perimeter of the drive plate is in the first zone and the second zone.

14. A cutter wheel for use with a stump cutter having a drive assembly configured to rotate the cutter wheel in a direction of rotation, the cutter wheel comprising:
a drive plate having a first side, a second side opposite the first side, an axis of rotation, and a perimeter;
a trailing cutter attached to one of the first side and the second side of the drive plate, the trailing cutter having:
a first leading surface,
a first trailing surface, and
a first zone in which the leading surface is substantially aligned with the perimeter of the drive plate;
a leading cutter attached to one of the first side and the second side of the drive plate and positioned ahead of the trailing cutter relative to the direction of rotation, the leading cutter having:
a second leading surface,
a second trailing surface, and
a second zone in which the trailing surface is substantially aligned with the perimeter of the drive plate; and
a reference arc centered on the axis of rotation, the reference arc having a first end in the first zone and a second end in the second zone, and
wherein the perimeter of the drive plate includes a transition portion extending between the leading and trailing cutters, radially below the reference arc, wherein the transition portion extends into both the first zone and the second zone.
